(19) United States
(12) Patent Application Publication
(10) Pub. No.: US 2026/0368283 A1
(43) Pub. Date: Nov. 19, 2026

(54) ARTIFICIAL INTELLIGENCE BASED METHODS AND SYSTEMS FOR ANOMALY PATTERN DETECTION IN DATASETS

(71) Applicant: MASTERCARD INTERNATIONAL INCORPORATED, Purchase, NY (US)

(72) Inventors: James HALL, San Anselmo, CA (US); Brandon CAMPBELL, Decatur, GA (US); Sayed Amin AFZAL, Chesterfield, MO (US); Adam LOPUCH, Norwalk, CT (US)

(73) Assignee: MASTERCARD INTERNATIONAL INCORPORATED, Purchase, NY (US)

(21) Appl. No.: 19/170,867

(22) Filed: Apr. 4, 2025

(51) Int. Cl. G06F 18/2433

(52) U.S. Cl. CPC G06F 18/2433

(57) ABSTRACT

A process includes obtaining a dataset having a plurality of data records that include time series data, determining a typology feature for a typology of interest of the dataset based on an exponentially decaying velocity of at least a portion of the plurality of data records. In response to the typology feature satisfying a typology condition, the process may provide input data features associated with the dataset that include at least a data feature relating to the exponentially decaying velocity of the portion of the plurality of data records into a machine learning anomaly classification model. The machine learning anomaly classification model may be operated on the input data features. In response to an output of the machine learning anomaly classification model satisfying an anomaly condition, an anomaly indicator that indicates that the dataset is an anomaly is stored in storage.

### CROSS-REFERENCE TO RELATED APPLICATIONS

This application is related to European Patent Application No. EP25168649, filed Apr. 4, 2025, entitled “DETECTING FRAUDULENT MERCHANTS”; and European Patent Application No. EP25168644, filed Apr. 4, 2025, entitled “DETECTING FRAUDULENT ACCOUNTS,” the contents of each of which are incorporated by reference in their entireties herein.

### BACKGROUND

As organizations grow, so does the volume of data from various sources. For example, credit card companies, insurance companies, manufactures, health care providers, retailers, electronic mail service providers, or other organizations, to name a few, may obtain thousands, tens of thousands, or millions of datasets for various customers, patients, vendors, and the like. Each dataset may include hundreds, thousands, or millions of data records. Those data records in turn may each have multiple data points or fields. Obtaining meaning from these datasets to find anomalous patterns across datasets can be time and resource intensive as well as inaccurate. Even with the advent of artificial intelligence and machine learning, finding meaning or anomalies from the datasets can be computationally resource intensive while less resource intensive methods such as various filtering techniques can lead to inaccuracies.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram illustrating an example of an anomaly pattern detection system for detecting anomaly patterns in datasets, according to some embodiments of the present disclosure;

FIG. 2 is a block diagram illustrating an example of an anomaly pattern detection computing device of the anomaly pattern detection system of FIG. 1, in accordance with some embodiments of the present disclosure;

FIG. 3 is a flow chart of a method of anomaly pattern detection, in accordance with some embodiments of the present disclosure;

FIG. 4 is a flow chart of a sub-method of determining a typology feature during the method of anomaly pattern detection of FIG. 3, in accordance with some embodiments of the present disclosure; and

FIG. 5 illustrates an example of a computer system that may be implemented by devices illustrated in FIG. 1 and FIG. 2, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of data mining, data storage, or artificial intelligence/machine learning. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As discussed above, uncovering anomaly patterns in datasets is inaccurate or computer resource intensive. Examples of anomalies that users may wish to uncover include, but are not limited to, errors in processes that result in datasets, money laundering activities or other fraudulent activities in payment transactions, diagnosis or prediction of disease in patients, identifying anomalies in genetic information, identifying inefficiencies, malfunctions, or improper use of machines or computer system, applications to securities trading (e.g., to identify market manipulation attempts, ecommerce promotion/discount abuse, insurance-related claims anomalies, or other anomaly patterns in various typologies that would be apparent to one of skill in the art in possession of the present disclosure. However, the volume of data and datasets that a user is required to sift through, the dynamic nature of some datasets changing over time as new data records are added, the relevance of data, or many other factors make finding anomalous datasets for further investigation or use in decision making challenging.

One example of anomaly pattern detection that will be discussed throughout the disclosure is the detection of money laundering activities from credit card transactions based on luxury goods purchases. While money laundering detection is discussed herein to illustrate the benefits of the anomaly pattern detection process, other anomalous typologies may be uncovered from financial transaction datasets or other types of datasets other than financial transactions, like those discussed above, will benefit from the anomaly detection teachings of present disclosure and therefore the example should not limit the scope of the present disclosure. That being said, luxury goods are often a popular target for money laundering. These items can serve as relatively easily acquired and easily transferable assets. For example, using credit cards, a money launderer may make it more difficult to trace where funds used to purchase the luxury good originated. In another example, luxury goods can be easily bought in one country, transported to another country, and sold in that country to avoid financial institution transaction detection across borders.

To address the issues discussed above with anomaly pattern detection, systems and methods of the present disclosure propose a solution by performing a filtering process that determines whether a dataset is associated with a typology of interest and then using machine learning such as an anomaly classification model, the system determines a risk or a classification of that dataset. By performing the filtering process on the entire corpus of datasets that may be dynamically updating by the second, minute, hour, day or period, the anomaly detection system may be able to quickly process many datasets and filter out a sizable portion of the datasets that do not follow the typology of interest with low computational processes. Furthermore, the filtering technique allows for a streaming aggregation of the data records in each dataset over time.

If the filtering process determines that the dataset has a pattern of a particular typology based on a calculated topology feature discussed herein, data records of the dataset and other features joined with the data records may be used as inputs into a machine learning anomaly classification model that classifies the dataset further detailing the typology associated with the dataset. These datasets may then be used to further train the classification model based on feedback from the user after analyzing the classification. This allows for a more accurate classification than the filter process alone but with less computer resource intensive activities than if the machine learning classification algorithm were to process the datasets that are often “streaming” or being dynamically updated.

For example, with respect to the detection of money laundering from the purchase of luxury goods example, the anomaly detection process may filter a dataset that includes a plurality data records (e.g., transaction records) for a particular user or account number by identifying approved transactions associated with a luxury good identifier and calculate an exponentially decaying velocity of approved luxury good transactions over a predetermined period of time. An anomaly risk feature is determined using a ratio of the luxury spending decayed velocity to the decayed velocity of the approved total value amount for all transactions for the account for the same period of time. In some embodiments, a weight may be applied to the ratio. An anomaly safe feature may also be calculated using the same process for luxury goods but using transactions that are identified with merchants that are generally not associated with luxury goods or not associated with money laundering schemes (e.g., a restaurant purchase). A remainder feature may then be calculated using a velocity of total values of the common data points in each data record (e.g., purchase amount), the anomaly safe score, and the anomaly risk score. In some embodiments, a refund feature may be calculated and used to determine the remainder feature. The refund feature may account for refunds of transaction in the dataset and may be calculated using approved refund amounts aggregated over the predetermined time of decay.

Using the remainer feature, the unweighted velocities for all transaction typologies and the refund feature a total comparable feature may be calculated that is then used to calculate a typology feature. The filtering process then uses the typology feature to determine whether the typology feature satisfies a condition for the luxury goods typology or more generally to the type of typology being filtered.

If the typology feature is identified as a luxury good typology, the transaction dataset may then be evaluated using the machine learning algorithm such as an anomaly classification model to determine a classification or risk for that dataset (e.g., whether the dataset is at risk as indicating money laundering or not). The features calculated for the filtering process along with other features and data from third party databases may be provided as inputs to the anomaly classification model. These inputs may include a product code; a product category; a predetermined time velocity of transaction to/from a risky issuer country, a risky merchant country, or a risky acquirer country; a predetermined interval velocity of approved transactions greater than a predetermined value as a ratio to total approved value, or other features. The risky merchants and countries may be obtained from lists maintained by third parties such as the Office of Foreign assets Control and the Financial Action Task Force (FATF). Using the input features, the anomaly classification model may determine a classification or risk score for the dataset (e.g., likely indicating money laundering or not) that then tags the dataset with the classification and sends alerts to an administrator. The filtering process and the classification process, if necessary, may be iterated for each dataset.

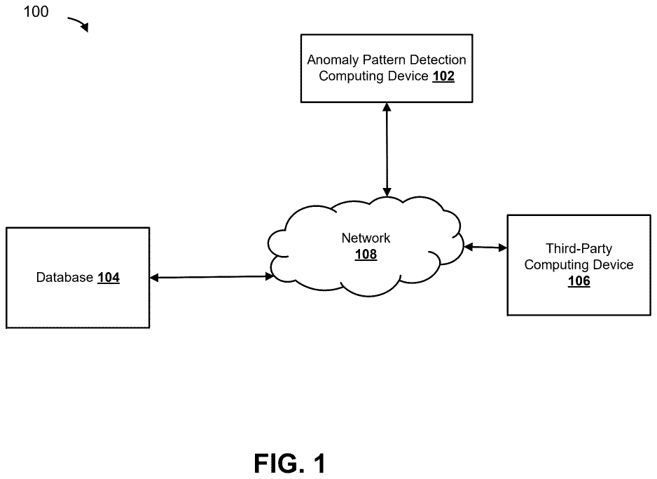

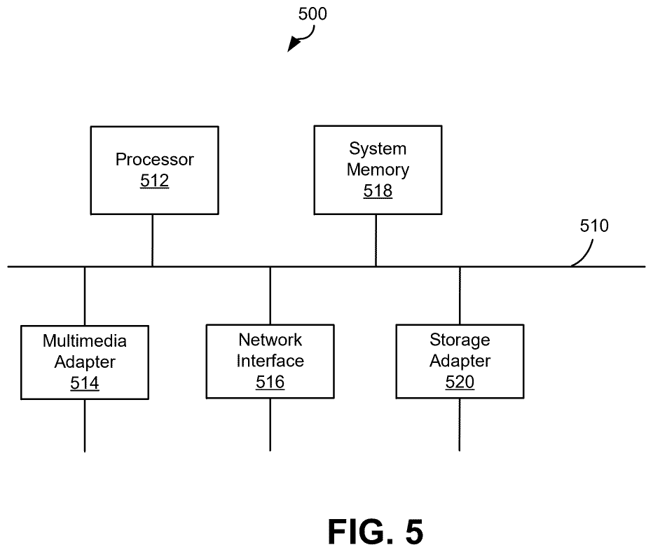

FIG. 1 depicts a block diagram of an example of an anomaly pattern detection system 100, consistent with some embodiments. In some embodiments, the anomaly pattern detection system 100 may include an anomaly pattern detection computing device 102, a dataset database 104, and a third-party data provider computing device 106. The anomaly pattern detection computing device 102, the dataset database 104, and the third-party data provider computing device 106 may be in communication with each other over a network 108. These various components may be implemented with computing devices like those shown in FIG. 5.

In various embodiments, the anomaly pattern detection system 100 may also include or may be in connection with the anomaly pattern detection computing device 102. For example, the anomaly pattern detection computing device 102 may include one or more server devices, storage systems, cloud computing systems, or other computing devices (e.g., desktop computing device, laptop/notebook computing device, tablet computing device, mobile phone, etc.). In various embodiments, anomaly pattern detection computing device 102 may also include various combinations of hardware or software having one or more processors and capable of reading instructions stored on a tangible non-transitory machine-readable medium for execution by the one or more processors. Consistent with some embodiments, the anomaly pattern detection computing device 102 includes a machine-readable medium, such as a memory (not shown) that includes instructions for execution by one or more processors (not shown) for causing the anomaly pattern detection computing device 102 to perform specific tasks. In some embodiments, the instructions may be executed by the one or more processors in response to interaction by the user. The anomaly pattern detection computing device 102 may further be one or more servers that hosts applications for the client computing devices (not illustrated) that may be administrator computing devices. The anomaly pattern detection computing device 102 may perform the filtering of datasets to identify a subset of datasets and the anomaly classification of those datasets using a classification model as wells as other processes discussed in more detail below.

In various embodiments, the anomaly pattern detection system 100 may also include or may be in connection with a dataset database 104. For example, the dataset database 104 may include one or more server devices, storage systems, cloud computing systems, or other computing devices (e.g., desktop computing device, laptop/notebook computing device, tablet computing device, mobile phone, etc.). In various embodiments, dataset database 104 may also include various combinations of hardware or software having one or more processors and capable of reading instructions stored on a tangible non-transitory machine-readable medium for execution by the one or more processors. Consistent with some embodiments, the dataset database 104 includes a machine-readable medium, such as a memory (not shown) that includes instructions for execution by one or more processors (not shown) for causing the dataset database 104 to perform specific tasks. In some embodiments, the dataset database 104 may store a plurality of datasets that include a plurality of data records each having a plurality of fields or data points. The plurality of datasets may be the datasets that the anomaly pattern detection computing device 102 filters. While illustrated as a separate computing device, the dataset database 104 may be included in the anomaly pattern detection computing device 102 such that the anomaly pattern detection computing device 102 is servicing its own datasets. In other embodiments, there may be a plurality of dataset databases 104 such that the anomaly pattern detection computing device 102 is acting as a service for various entities and their data.

In various embodiments, the anomaly pattern detection system 100 may also include or may be in connection with the third-party data provider computing device 106. For example, the third-party data provider computing device 106 may include one or more server devices, storage systems, cloud computing systems, or other computing devices (e.g., desktop computing device, laptop/notebook computing device, tablet computing device, mobile phone, etc.). In various embodiments, the third-party data provider computing device 106 may also include various combinations of hardware or software having one or more processors and capable of reading instructions stored on a tangible non-transitory machine-readable medium for execution by the one or more processors. Consistent with some embodiments, the third-party data provider computing device 106 includes a machine-readable medium, such as a memory (not shown) that includes instructions for execution by one or more processors (not shown) for causing the third-party data provider computing device 106 to perform specific tasks. In some embodiments, the third-party data provider computing device 106 may provide data via an API to the anomaly pattern detection computing device 102 that is used to supplement the features provided as inputs into the anomaly classification model. While a specific anomaly pattern detection system is illustrated in FIG. 1, one of skill in the art in possession of the present disclosure will recognize that other components and configurations are possible, and thus will fall under the scope of the present disclosure.

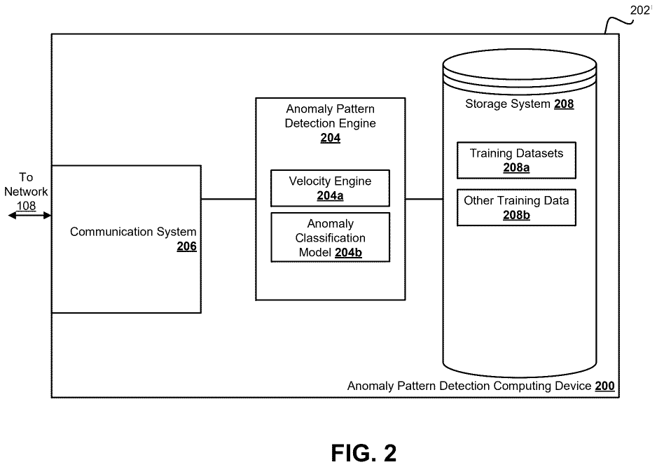

FIG. 2 illustrates an embodiment of an anomaly pattern detection computing device 200 that may be the anomaly pattern detection computing device 102 discussed above with reference to FIG. 1. In the illustrated embodiment, the anomaly pattern detection computing device 200 includes a chassis 202 that houses the components of the anomaly pattern detection computing device 200. Several of these components are illustrated in FIG. 2. For example, the chassis 202 may house a processing system and a non-transitory memory system that includes instructions that, when executed by the processing system, cause the processing system to provide an anomaly pattern detection engine 204 that is configured to perform the functions of the anomaly pattern detection engine or the anomaly pattern detection computing devices, discussed below. In the specific example illustrated in FIG. 2, the anomaly pattern detection engine 204 is configured to provide a velocity engine 204a and an anomaly classification model 204b. The velocity engine 204a may be used to calculate exponentially decay velocities of the data records in a dataset for use in the filtering process performed by the anomaly pattern detection engine 204. The anomaly classification model 204b may provide the machine learning algorithm that performs an anomaly classification, training, and performs other functions of the anomaly classification model or the anomaly pattern detection computing devices discussed below

The chassis 202 may further house a communication system 206 that is coupled to the anomaly pattern detection engine 204 (e.g., via a coupling between the communication system 206 and the processing system). The communication system 206 may include software or instructions that are stored on a computer-readable medium and that allow the anomaly pattern detection computing device 200 to send and receive messages through the communication networks discussed above. For example, the communication system 206 may include a communication interface to provide for communications through the network 108 as detailed above (e.g., first (e.g., long-range) transceiver). In an embodiment, the communication interface may include a wireless antenna that is configured to provide communications with IEEE 802.11 protocols (Wi-Fi), cellular communications, satellite communications, other microwave radio communications or communications. The communication system 206 may also include a communication interface (e.g., the second (e.g., short-range) transceiver) that is configured to provide direct communication with other user computing devices, sensors, storage devices, beacons, and other devices included in the securitization system discussed above with respect to FIG. 1. For example, the communication interface may include a wireless antenna that configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), or other wireless communication protocols that allow for direct communication between devices.

The chassis 202 may house a storage device (not illustrated) that provides a storage system 208 that is coupled to the anomaly pattern detection engine 204 through the processing system. The storage system 208 may be configured to store data, applications, training datasets 208a, other training data 208b, or instructions described in further detail below and used to perform the functions described herein. While a specific example of the anomaly pattern detection computing device 200 is illustrated, one of skill in the art in possession of the present disclosure will recognize that different configurations may be contemplated without departing from the scope of the present disclosure.

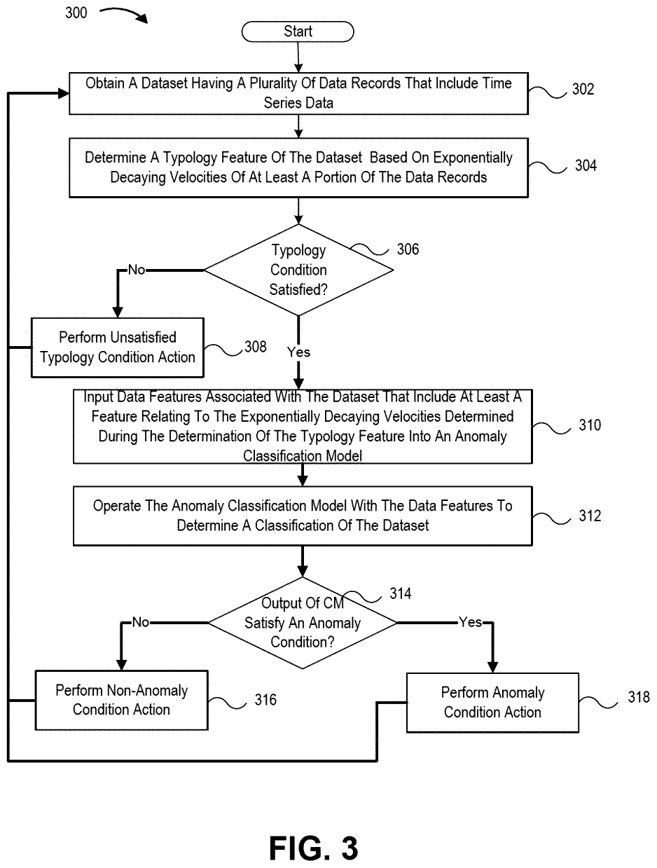

FIG. 3 depicts an embodiment of a method 300 of anomaly pattern detection, which in some embodiments may be implemented with the components of FIGS. 1 and 2 discussed above. As discussed herein, some embodiments make technological improvements to machine learning, data mining and data analysis, and other computer-centric technology. In a variety of scenarios, the systems and methods of the present disclosure may be useful identify anomalous datasets and further defining a classification or risk for those anomalous datasets with fewer computer resources, shorter processing times, analysis of streaming datasets that are periodically being updated, more accurate classifications or other technological benefits that would be apparent to one of skill in the art in possession of the present disclosure. One of skill in the art in possession of the present disclosure will recognize that Internet-centric and content management problems, along with other computer-centric problems, are solved or mitigated by some of these embodiments. Again, though, embodiments are not limited to approaches that address these problems, as various other problems may be addressed by other aspects of the present disclosure, which is not to suggest that any other description is limiting.

The method 300 may include block 302 where a dataset that includes a plurality of data records that include time series data is obtained. In an embodiment, at block 302, the anomaly pattern detection engine 204 of the anomaly pattern detection computing device 200 may obtain one or more datasets from the dataset database 104 via the network 108. The datasets may include a plurality of data records that are periodically being updated and thus associated with time series data. The data records themselves may include a plurality of fields or data points.

With respect to the credit card transaction example discussed herein, the dataset may be a corpus of credit card transactions for a credit card or a user. As such, the dataset may be identified by a credit card or a user associated with the credit card where credit card transactions (e.g., the data records) are being periodically updated and may include a plurality of fields (e.g., a merchant, a transaction amount, a date, a time, a location, a merchant category code, or other data points or fields that would be apparent to one of skill in the art in possession of the present disclosure.

In some embodiments, the dataset may be obtained periodically based on a predetermined schedule. In some embodiments, the dataset may be tagged or otherwise identified as having a higher priority to undergo the operations of method 300 than other datasets. For example, the datasets that have been processed according to method 300 in the past may have been identified as satisfying a typology condition of decision block 306 but not satisfying the anomaly condition of decision block 314 and require more frequent monitoring than a dataset that does not satisfy the typology condition of decision block 306 discussed below. That frequency of monitoring may be further fine-tuned based on an overall risk score during the anomaly classification by the anomaly classification model 204b. By having a hierarchy of dataset processing, the method 300 may reduce network and computational resource consumption by reducing processing of datasets that are not of a typology of interest or that are designated as low risk compared to those that are of higher risk.

The method 300 may proceed to block 304 where a typology of the dataset is determined using a filtering operation on the data records based on exponentially decay velocities of at least a portion of the data records. In an embodiment, at block 304, the anomaly pattern detection engine 204 using the velocity engine 204a may determine a typology feature of the dataset. The typology feature may be determined based on the typology that is of interest and calculated based on exponentially decaying velocities of the time series data records. The operation of block 304 is described as a filtering operation as it can be used to filter datasets from the hundreds, thousands, or millions of datasets stored in the dataset database 104 before entering the anomaly classification model 204b that may be resource intensive. In conjunction with the example discussed herein with respect to money laundering using credit cards to purchase luxury goods, the typology at block 304 may be used to determine a typology feature, such as a scoring the dataset relative to luxury good purchases. The typology feature may be determined based on the time series data records by determining exponentially decaying velocities of various subsets of data records of the dataset.

Exponential decay velocities or rates are analogous to typical windowed counts but in a streaming context. The velocity engine 204a uses these features to capture anomalous behavior while keeping the amount of history required to store counts at a minimum. Instead of storing and counting all transactions within a window of time, the velocity engine 204a may leverage the exponential function to store only a single previous decay value. The exponential function also allows us to naturally include a time weighted component to the calculations to better detect rate changes more naturally.

The exponential decay is defined as:

y′=x+y*exp(LN(0.5)*time_delta/decay_rate)

where, “x” is a value used to update decay, “y” is a previous value of decay, “time_delta” is the time difference in seconds between the last update of the decay and the current time, “decay_rate” is the decay rate for the exponential decay in seconds, LN( ) is the natural logarithm, and “y′” is the updated decay value. The unit for the “time_delta” and the “decay_rate” must be the same.

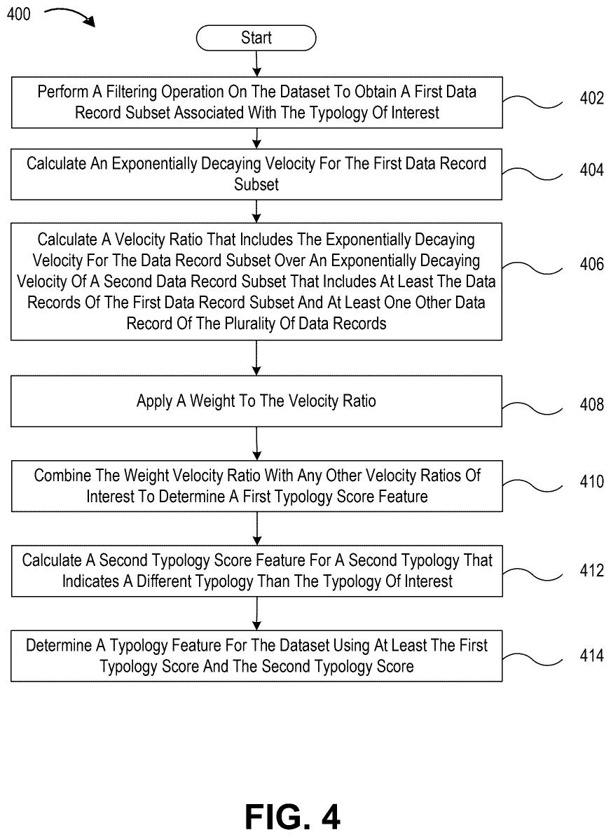

A sub-method 400 of FIG. 4 describes in more detail the typology feature determination of block 304. Referring to FIG. 4, the sub-method 400 of determining a typology feature of a dataset is described. In an embodiment, the sub-method 400 may begin at block 402 where a filtering operation on a dataset that includes a plurality of data records each having a plurality of fields to obtain a data record subset is performed. In an embodiment, at block 402, the anomaly pattern detection engine 204 may obtain data records of a certain typology (e.g., a typology of interest) by searching a common field across the datasets. For example, the anomaly pattern detection engine 204 may search for data records that include a luxury good merchant category code (MCC) to identify transactions involving luxury or unique items. A predefined list of MCCs associated with high-risk categories (e.g., jewelry stores, art dealers, yacht brokers, or the like) may be used for that purpose. In other embodiments, additional features may be searched to filter the data records of the dataset to obtain the data record subset. For example, the anomaly pattern detection engine 204 may only be interested in approved transactions in the credit card example.

The sub-method 400 may proceed to block 404 where an exponentially decaying velocity is calculated for the data record subset. In an embodiment, at block 404, the anomaly pattern detection engine 204 may provide the data record subset to the velocity engine 204a. The velocity engine 204a may calculate an exponentially decaying velocity of the data record subset using the equation above and using another data point or field in each data record of the data record subset than what was used to filter the data, typically a value field. Instead of storing and counting all values across various data records within a window of time, the velocity engine 204a may leverage the exponential function to store only a single previous decay value. In the luxury goods example, the field entered into the velocity engine 204a for the dataset may be the value of the transaction and the time window of the velocity calculation may be 56 days, however, other time windows may be contemplated without departing from the scope of the present disclosure.

The sub-method 400 may proceed to block 406 where a velocity ratio for a predetermined time interval that includes the exponentially decaying velocity of the data record subset over an exponentially decaying velocity of the plurality of data records of the dataset is calculated. In an embodiment, at block 406, the anomaly pattern detection engine 204 may calculate a velocity ratio for a predetermined time frame that includes the exponentially decaying velocity of the data record subset over an exponentially decaying velocity of the plurality of data records of the dataset. The anomaly pattern detection engine 204 may use the velocity engine 204a to calculate the decaying velocity of the field across the entire set of data records or a second subset thereof for the dataset and divide the velocity of the subset determined in block 404 by this velocity to obtain a ratio. An example, ratio equation may be:

Ratio=((v₁+1)/(v_{T}+1))²

where “v₁” is the velocity of the data record subset and “v_{T}” is the velocity of the plurality of data records or a second data record subset. For example, v₁ may be the velocity of the transaction amounts of the approved luxury good transactions while v_{T} may be the velocity of the transactions of all approved transactions in all MCCs.

The sub-method 400 may proceed to block 408 where a weight may be applied to the velocity ratio. In an embodiment, at block 408, a predetermined weight may be applied to the velocity ratio. For example, a weight of 0.6, 0.7, or 0.8 may be applied. The weight may be applied if other velocity ratios are combined with the particular velocity ratio for the identified data record subset. For example, other data record subsets may provide insight into the typology. In the example for identifying a luxury good typology, typologies such as gambling, ATM transactions, or others may be contributing factors. As such, velocity ratios may be calculated for those data record subsets that are associated with their own set of MCCs to add insight into the typology feature.

The sub-method 400 may proceed to block 410 where the weighted velocity ratios are combined to calculate a typology score feature. In an embodiment, at block 410, the anomaly pattern detection engine 204 may combine the weighted velocity ratios into a typology score feature. For example, the weighted luxury good velocity ratio may be combined with a weighted gambling velocity ratio to obtain a luxury good risk score feature.

The sub-method 400 may proceed to block 412 where a second typology score feature is calculated. In an embodiment, at block 412, the anomaly pattern detection engine 204 may use blocks 402-410 to calculate a second typology score feature that represents other typologies of the dataset. In the luxury good example, the second typology score feature may be for transactions that have been identified as being transactions that are not associated with money laundering activities. As such, the anomaly pattern detection engine 204 may filter out a data record subset of transactions for safe MCCs and determine a velocity ratio of those according to the processes above to obtain a typology safe score feature.

The sub-method 400 may proceed to block 414 where a typology feature is determined from the first typology score and the second typology score. In an embodiment, at block 414, the first typology score and the second typology score may be used to determine a typology feature of the dataset. The typology feature may be a score indicating whether the dataset is representative of the typology of interest that is being determined by the sub-method 400. For example, the typology feature may indicate whether the dataset is of a luxury good type. In the luxury good example, further features of the dataset are extracted to determine the typology feature. For example, in addition to the luxury good risk score feature and the typology safe score feature, a refund feature may be a velocity and may be calculated that includes the approved refund amounts of the transactions of the dataset, which may be the aggregated amounts of the refunds over the interval of the velocity calculations. Furthermore, a total approved amount feature may be calculated for all approved amounts from any MCC that is aggregated over the time interval. The total approved amount feature may be calculated using the following equation:

usd=vₙ+2*refund_usd

where “usd” is the total approved amount feature, “vₙ” is the exponential decay velocity of the total spend transactions for the time interval and “refund_usd” is the refund feature, which may also be a velocity.

A remainder feature may also be calculated with the following equation:

Remainder=−0.2*(usd−safe_usd−(risk_usd+refund_usd))
where “safe_usd” is the typology safe score feature and “risk_usd” is the luxury good risk score feature.

An all-comparable feature may then be calculated using the Reminder, which may be the equation:

all_comps=refund_usd+unweighted velocities for all typologies+0.2*Remainder

Using the all-comparable feature, the typology feature for the dataset may be determined. The typology feature may be determined by the following equation:

Typ_fea=NVL(v₁,0)/all_comps

The typology feature may be used in decision block 306 below. While a specific example of determining the typology feature is illustrated, the typology feature may be determined in various ways depending on the dataset, the typology of interest being searched, the types of data fields being analyzed, or other factors without departing from the scope of the present disclosure.

Referring again to FIG. 3, the method 300 may proceed to decision block 306 where it is determined whether the typology feature satisfies a typology condition. In an embodiment at decision block 306, the anomaly pattern detection engine 204 may determine whether the typology feature calculated at block 304 satisfies a typology condition. For example, a typology condition may be a value that is determined to be a threshold in identifying a particular typology of the data set. For example, the typology condition may indicate whether the dataset includes credit card transactions that follow a luxury good typology such that there could be a potential that money laundering activities are occurring. The anomaly pattern detection engine 204 may compare the typology feature, which may be a value, to the typology condition value and determine whether it satisfies the threshold or not.

If at decision block 306, the typology feature does not satisfy the typology condition, the method 300 may proceed to block 308, where an unsatisfied typology condition action may be performed. In an embodiment, at block 308, the unsatisfied typology condition action may include anomaly pattern detection engine 204 returning to block 302 such that another dataset may be obtained. In some embodiments, the anomaly pattern detection engine 204 may use the typology feature to classify the dataset further depending on the delta between the typology condition and the typology feature such that the frequency of anomaly pattern detection for the dataset is less or more frequent than others. For example, a typology feature and typology condition having a large delta may be processed again at a first interval. A typology feature and typology condition having a small delta may be processed again at a second interval that is shorter than the first interval. In a specific example, if the dataset's typology feature indicates that the credit card transactions do not include any luxury goods, that data set may not be analyzed again for a year while a dataset's typology feature that indicates that there is some luxury good purchases but not enough to cause it to be classified as a luxury good typology (e.g., a smaller delta) may be checked again more frequently (e.g., once per month). This logic helps reduce network and computational resource consumption such that datasets that are likely not going to indicate a luxury good typology or the typology that the system is trying to identify are not being processed to frequently or at all in subsequent iterations of method 300 on that dataset.

If, at decision block 306, the typology feature does satisfy the typology condition, the method 300 may proceed to block 310, where data features associated with the dataset that include at least a feature relating to the exponentially decaying velocities determined during the determination of the typology feature are provided as inputs to an anomaly classification model. In an embodiment, at block 310, the anomaly pattern detection engine 204 may provide, as anomaly classification model inputs, data features associated with the dataset where the data features include at least a data feature relating to the exponentially decaying velocities determined during the determination of the typology feature. The data features may include data transformed by data obtained from the third-party data provider computing device 106 via the network 108 and an application programming interface (API) call. In some embodiments, the data features may include the raw data obtained from the third-party data provider computing device 106 With respect to the specific money laundering detection discussed herein, the inputs provided to the anomaly classification model 204b may include a product code, a product category, a merchant code; velocities of transactions to or from a risky issuer country, a risky merchant, a risky acquirer country, or other velocities; or other data features that would be apparent to one of skill in the art in possession of the present disclosure.

The method 300 may proceed to block 312 where the anomaly classification model is operated with the input data features to determine a classification of the dataset. In an embodiment, at block 312, the anomaly classification model 204b may determine a classification or risk score of the dataset. The anomaly classification model 204b may output a plurality of output features that may be aggregated into an output risk score or classification of the dataset. For example, the output features may include outputs at the dataset level to give context to the classification score or direct output fields from the model at the data record level to give context to specific data records that are affecting the classification. In the credit card example for identifying money laundering, the output may include an overall classification or money laundering risk score but may also include outputs related to the transaction dataset and the individual transactions themselves. For example, a transaction dataset output may include a max risk score that indicates the transaction with the maximum score observed, a number of transactions, total transaction amount, a number of transactions over various predetermined amounts, a number of transactions in various transaction types (e.g., luxury, automated teller machine (ATM), gambling, money send, cross border, refunds, high risk acquirer), or other outputs that would be apparent to one of skill in the art in possession of the present disclosure. At the transaction record level, outputs may include a money laundering risk score for the transaction, a reason for the score, a country of the merchant, an MCC of a merchant, a country of a merchant, a transaction identifier, a date of the transaction, a time of the transaction, or other data features that would be apparent to one of skill in the art in possession of the present disclosure.

The method 300 may proceed to decision block 314 where it is determined whether an anomaly condition is satisfied. In an embodiment, at decision block 314, the anomaly pattern detection engine 204 may determine whether the classification or anomaly score determined at block 312 satisfies an anomaly condition. For example, the anomaly pattern detection engine 204 may determine whether the value of the anomaly score satisfies or does not satisfy a value defined by the anomaly condition. In other embodiments, the anomaly condition may be determined when a set of certain outputs of the plurality outputs satisfies the more than one anomaly sub-conditions.

If, at decision block 314, the anomaly condition is not satisfied, the method 300 may proceed to block 316 where a non-anomaly condition action is performed. For example, the dataset may be ignored or tagged as being low risk such that it is processed less frequently for anomaly pattern detection according to method 300. In some embodiments, the dataset may be process more than a dataset that did not satisfy the topology condition. However, if at decision block 314, the anomaly condition is satisfied, the method 300 may proceed to block 318 where an anomaly condition action is performed. For example, the anomaly pattern detection engine 204 may notify an administrator or another third party (e.g., the bank that is funding the credit card) and present the classification as well as other outputs from the anomaly classification model 204b. In other embodiments, the dataset may be tagged as being high risk and stored with the classification in the dataset database 104 such that the dataset is selected more frequently for anomaly pattern detection.

Thus, the systems and method of the present disclosure provide anomaly pattern detection in datasets. By using a filtering operation to determine whether a dataset is associated with typology of interest, using exponentially decaying velocities of the datasets in that typology determination, and then only inputting data features for those datasets that are of a typology of interest into an anomaly classifier, the systems and methods provide various improvements and efficiencies other anomaly pattern detection systems, machine learning, and computer technologies. As such, a reduction in processing time, computer resources including processing instances, storage, memory usage, and network resources, and more accurate results may be realized in many instances.

FIG. 5 illustrates an example of a computer system 500 that may be implemented by devices illustrated in FIG. 1. The computer system 500 may be part of or include the anomaly pattern detection system 100 to perform the functions and features described herein. For example, various ones of the devices of anomaly pattern detection system 100 may be implemented based on some or all the computer system 500. The computer system 500 may include, among other things, an interconnect 510, a processor 512, a multimedia adapter 514, a network interface 516, a system memory 518, and a storage adapter 520.

The interconnect 510 may interconnect various subsystems, elements, and/or components of the computer system 500. As shown, the interconnect 510 may be an abstraction that may represent any one or more separate physical buses, point-to-point connections, or both, connected by appropriate bridges, adapters, or controllers. In some examples, the interconnect 510 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 510 may allow data communication between the processor 512 and system memory 518, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 512 may control operations of the computer system 500. In some examples, the processor 512 may do so by executing instructions such as software or firmware stored in system memory 518 or other data via the storage adapter 520. In some examples, the processor 512 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 514 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 516 may provide the computer system 500 with an ability to communicate with a variety of remote devices over a network. The network interface 516 may include, for example, an Ethernet adapter, a Fibre Channel adapter, and/or other wired-or wireless-enabled adapter. The network interface 516 may provide a direct or indirect connection from one network element to another and facilitate communication to and between various network elements. The storage adapter 520 may connect to a standard computer readable medium for storage and/or retrieval of information, such as a fixed disk drive (internal or external).

Other devices, components, elements, or subsystems (not illustrated) may be connected in a similar manner to the interconnect 510 or via a network. The devices and subsystems can be interconnected in different ways from that shown in FIG. 1. Instructions to implement various examples and implementations described herein may be stored in computer-readable storage media such as one or more of system memory 518 or other storage. Instructions to implement the present disclosure may also be received via one or more interfaces and stored in memory. The operating system provided on computer system 500 may be MS-DOS®, MS-WINDOWS®, OS/2®, OS X®, IOS®, ANDROID®, UNIX®, Linux®, or another operating system.

The databases (such as 104) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompass substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A tangible, non-transitory, machine-readable medium storing instructions that when executed by one or more processors effectuate operations comprising:
obtaining, by a computer system, a dataset having a plurality of data records that include time series data;
determining, by the computer system, a typology feature for a typology of interest of the dataset based on an exponentially decaying velocity of at least a portion of the plurality of data records;
in response to the typology feature satisfying a typology condition, providing, by the computer system, input data features associated with the dataset that include at least a data feature relating to the exponentially decaying velocity of the portion of the plurality of data records into a machine learning anomaly classification model;
operating, by the computer system, the machine learning anomaly classification model; and
in response to an output of the machine learning anomaly classification model satisfying an anomaly condition, storing, by the computer system, an anomaly indicator that indicates that the dataset is an anomaly in storage.

2. The tangible, non-transitory, machine-readable medium of claim 1, wherein the determining the typology feature comprises:
performing, by the computer system, a filtering operation on the dataset to obtain a first data record subset associate with a typology of interest;
calculating, by the computer system, a first exponentially decaying velocity for the first data record subset;
calculating, by the computer system, a second exponentially decaying velocity for a second data record subset that includes at least data records of the first data record subset and another portion of the plurality of data records;
determining, by the computer system, a first velocity ratio of the first exponentially decaying velocity in relation to the second exponentially decaying velocity;
determining, by the computer system, a first typology score feature based on the first velocity ratio; and
determining, by the computer system, a second typology score feature for a different typology of interest than the typology of interest, wherein the typology feature is determined based on the first typology score feature and the second typology score feature.

3. The tangible, non-transitory, machine-readable medium of claim 2, wherein a weight is applied to the first velocity ratio to generate a first weighted velocity ratio.

4. The tangible, non-transitory, machine-readable medium of claim 3, wherein the first weighted velocity ratio is combined with a second weighted velocity ratio for a different typology of interest than the typology of interest when determining the first typology score feature.

5. The tangible, non-transitory, machine-readable medium of claim 4, wherein the typology of interest and the different typology of interest are indicators of an anomalous dataset.

6. The tangible, non-transitory, machine-readable medium of claim 1, wherein the operations further comprise:
in response to the typology feature not satisfying the typology condition, storing an indicator with the dataset indicating that the dataset is not associated with the typology of interest; and
obtaining a second dataset to determine whether the second dataset is anomalous.

7. The tangible, non-transitory, machine-readable medium of claim 1, wherein the operations further comprise:
in response to the output of the machine learning anomaly classification model not satisfying the anomaly condition, storing an indicator with the dataset indicating that the dataset is associated with the typology of interest but not anomalous; and
obtaining a second dataset to determine whether the second dataset is anomalous.

8. The tangible, non-transitory, machine-readable medium of claim 7, wherein the operations further comprise:
queuing the dataset for processing at a subsequent time based on the indicator and indicators of other datasets in a dataset database.

9. The tangible, non-transitory, machine-readable medium of claim 1, wherein the typology feature includes a luxury good typology feature, and the anomaly is money laundering risk.

10. A method, comprising:
obtaining, by a computer system, a dataset having a plurality of data records that include time series data;
determining, by the computer system, a typology feature for a typology of interest of the dataset based on an exponentially decaying velocity of at least a portion of the plurality of data records;
in response to the typology feature satisfying a typology condition, providing, by the computer system, input data features associated with the dataset that include at least a data feature relating to the exponentially decaying velocity of the portion of the plurality of data records into a machine learning anomaly classification model;
operating, by the computer system, the machine learning anomaly classification model; and
in response to an output of the machine learning anomaly classification model satisfying an anomaly condition, storing, by the computer system, an anomaly indicator that indicates that the dataset is an anomaly in storage.

11. The method of claim 10, wherein the determining the typology feature comprises:
performing, by the computer system, a filtering operation on the dataset to obtain a first data record subset associate with a typology of interest;
calculating, by the computer system, a first exponentially decaying velocity for the first data record subset;
calculating, by the computer system, a second exponentially decaying velocity for a second data record subset that includes at least data records of the first data record subset and another portion of the plurality of data records;
determining, by the computer system, a first velocity ratio of the first exponentially decaying velocity in relation to the second exponentially decaying velocity;
determining, by the computer system, a first typology score feature based on the first velocity ratio; and
determining, by the computer system, a second typology score feature for a different typology of interest than the typology of interest, wherein the typology feature is determined based on the first typology score feature and the second typology score feature.

12. The method of claim 11, wherein a weight is applied to the first velocity ratio to generate a first weighted velocity ratio.

13. The method of claim 12, wherein the first weighted velocity ratio is combined with a second weighted velocity ratio for a different typology of interest than the typology of interest when determining the first typology score feature.

14. The method of claim 13, wherein the typology of interest and the different typology of interest are indicators of an anomalous dataset.

15. The method of claim 10, further comprising:
in response to the typology feature not satisfying the typology condition, storing an indicator with the dataset indicating that the dataset is not associated with the typology of interest; and
obtaining a second dataset to determine whether the second dataset is anomalous.

16. The method of claim 10, further comprising:
in response to the output of the machine learning anomaly classification model not satisfying the anomaly condition, storing an indicator with the dataset indicating that the dataset is associated with the typology of interest but not anomalous; and
obtaining a second dataset to determine whether the second dataset is anomalous.

17. The method of claim 16, further comprising:
queuing the dataset for processing at a subsequent time based on the indicator and indicators of other datasets in a dataset database.

18. The method of claim 10, wherein the typology feature includes a luxury goods typology feature, and the anomaly is money laundering risk.

19. A system, comprising:
one or more processors; and
memory storing instructions that when executed by the one or more processors cause the one or more processors to effectuate operations, including:
obtaining a dataset having a plurality of data records that include time series data;
determining a typology feature for a typology of interest of the dataset based on an exponentially decaying velocity of at least a portion of the plurality of data records;
in response to the typology feature satisfying a typology condition, providing input data features associated with the dataset that include at least a data feature relating to the exponentially decaying velocity of the portion of the plurality of data records into a machine learning anomaly classification model;
operating the machine learning anomaly classification model; and
in response to an output of the machine learning anomaly classification model satisfying an anomaly condition, storing an anomaly indicator that indicates that the dataset is an anomaly in storage.

20. The system of claim 19, wherein the determining the typology feature comprises:
performing a filtering operation on the dataset to obtain a first data record subset associate with a typology of interest;
calculating a first exponentially decaying velocity for the first data record subset;
calculating a second exponentially decaying velocity for a second data record subset that includes at least data records of the first data record subset and another portion of the plurality of data records;
determining a first velocity ratio of the first exponentially decaying velocity in relation to the second exponentially decaying velocity;
determining a first typology score feature based on the first velocity ratio; and
determining a second typology score feature for a different typology of interest than the typology of interest, wherein the typology feature is determined based on the first typology score feature and the second typology score feature.
